(19) United States
(12) Patent Application Publication
(10) Pub. No.: US 2005/0095929 A1
(43) Pub. Date: May 5, 2005

(54) Transmission system

(76) Inventor: David Lekhtman, Beaconsfield (CA)

Correspondence Address: Future Beach Corporation, 181 Onelda Drive, Pointe Claire, QC, H9R 1A9, CA

(21) Appl. No.: 10/836,316

(22) Filed: May 3, 2004

Related U.S. Application Data
(60) Provisional application No. 60/467,154, filed on May 2, 2003.

(51) Int. Cl. B63H 16/20; B62D 5/06

(52) U.S. Cl. 440/29

(57) ABSTRACT

The invention relates to a transmission system for human powered or motorized mechanisms using a flexible elongate belt having lateral protrusions that are engagable with peripheral recesses in drive wheels, driven wheels, and idler wheels at multiple orientations

### TECHNICAL FIELD

The invention relates to a transmission system for human powered or motorized mechanisms using a flexible elongate belt having lateral protrusions that are engagable with peripheral recesses in drive wheels, driven wheels, and idler wheels at multiple orientations

### BACKGROUND OF THE ART

The description and drawings herein use the example of a human pedal powered recreational aquatic vehicle propelled through the water with a rotary propeller. It will be understood however, that this example is only used to highlight some of the advantages of the invention including low cost, ease of manufacture, optional lubrication methods and adaptability to plastic molding methods. The mechanical transmission system is applicable to any mechanical device including human and motor powered vehicles or machinery of any type.

In the example of recreational aquatic vehicles, they must be: extremely low cost; practically maintenance free; and very simple to operate in order to be commercial viable. Molded plastic components are well recognized as being low cost and accurate, and increasingly plastic components are replacing traditional metal components in high wear, high heat applications as materials evolve. An example of a plastic transmission system is provided in the inventor's U.S. Pat. Nos. 6,135,835 issued Oct. 24, 2000 and 6,231,406 issued May 15, 2001. However, metal often remains the designer's material of choice when motorized components are used, despite the relatively high cost and weight penalty, due to heat and wear resistance.

It is an object of the invention to produce a transmission system that can be adapted to a wide variety of geometries without excessive complexity, friction or wear difficulties.

It is an object of the present invention to provide a mechanical transmission mechanism for various that can be produced inexpensively enough to render it practical for a large number of applications.

It is a further object of the invention to provide a transmission system that can be produced using conventional plastic molding techniques.

Further objects of the invention will be apparent from review of the disclosure, drawings and description of the invention below.

### DISCLOSURE OF THE INVENTION

The invention relates to a transmission system for human powered or motorized mechanisms using a flexible elongate belt having lateral protrusions that are engagable with peripheral recesses in drive wheels, driven wheels, and idler wheels at multiple orientations. The invention provides a pedal powered drive mechanism having a tranverse axis and a longitudinal axis with a housing and a drive belt having a central band spaced apart protrusions extending from the band The output shaft is journalled in the housing aligned with the longitudinal axis having a driven wheel with circumferential recesses mating the protrusions of the belt with a crank shaft journalled in the housing aligned with the transverse axis having a drive wheel with circumferential recesses mating the protrusions of the belt.

### DESCRIPTION OF THE DRAWINGS

In order that the invention may be readily understood, one embodiment of the invention is illustrated by way of example in the accompanying drawings.

FIG. 1 is a perspective view of an embodiment of the invention where a pedal powered drive wheel, with belt guided by idler wheels drives a driven wheel mounted on a shaft to rotate a propeller.

FIG. 2 is a perspective view of the belt showing the disc shaped protrusions spaced apart and mounted on a flexible band at the core of the belt.

FIG. 3 is a perspective view of the wheels and belt mounted within a support housing.

FIG. 4 is a longitudinal cross-sectional view through an embodiment showing an aquatic vehicle with saddle seat, a T-bar steering column and a forward sump within which is housed with a pedal powered transmission system, a longitudinal drive shaft and folding propeller.

FIG. 5 is transverse cross sectional view along lines 5-5 of FIG. 4 illustrating the cross sectional shape of the hull with lateral outriggers, partially water filled sump and central body with downwardly extended keel.

FIG. 6 is an exploded view of vehicle components showing the saddle seat with arcuate lower edge and teeth for position adjustment, the T-bar steering column which inserts into the blow molded cover over the sump and the transmission system.

Further details of the invention and its advantages will be apparent from the detailed description included below.

### DETAILED DESCRIPTION OF PREFERRED EMBODIMENTS

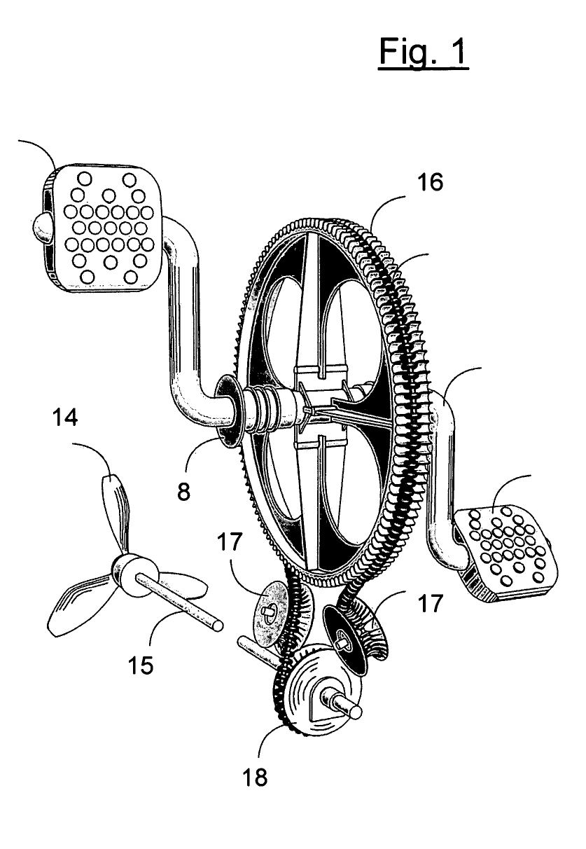

As shown in FIGS. 1-3 the example involves a pedal powered transmission system 1 where a crank shaft 8 with a pair of pedal crank arms are journaled for rotation about a transverse axis. In the embodiment illustrated, the shaft 8 has a drive wheel 16 that includes recesses on its periphery to engage the belt 6. The belt 6 runs over idler wheels 17 that serve to twist the tension and align the belt 6 through to engage a driven wheel 18 mounted on the inward end of the longitudinal shaft 15.

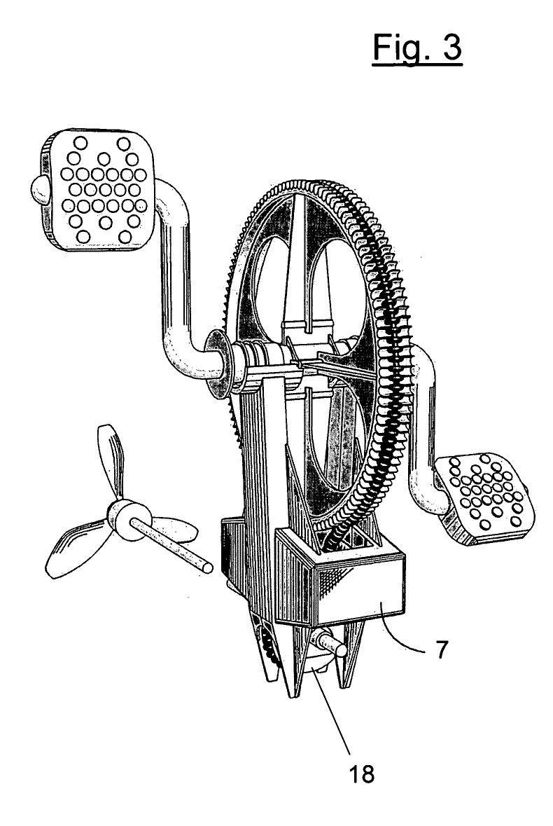

Support for the wheels 16, 17, 18 is provided by a split housing 7, shown in FIG. 3, which is preferably formed of molded plastic. In view of the inventor's U.S. Pat. Nos. 6,135,835 and 6,231,406, incorporated herein by reference, it is not considered necessary to explain in detail the manner of mounting the components in the housing 7 since this will be apparent to those skilled in the art.

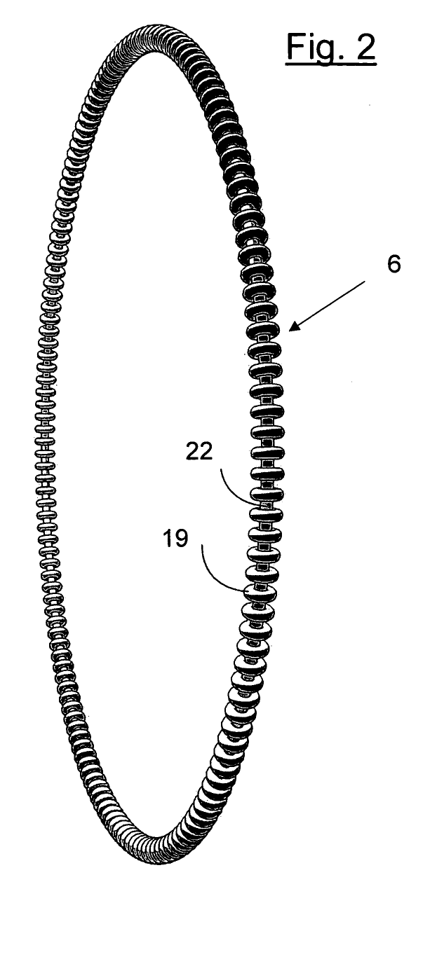

As best shown in FIGS. 1 and 2 the belt 6 includes a spaced apart series of protrusions 19 mounted on a flexible band 22. The wheels 16-18 include matching recesses to engage the protrusions 19 and drive the belt 6. Preferably, the belt 6 has protrusions 19 that enable engagement between the belt 6 and the wheels 16-18 at multiple angles.

Conventional drive belts have rectangular or trapezoidal cross-sections that enable engagement with pulleys, sprockets or serrated wheels operating to drive the belt within a flat plane where the wheels are mounted on parallel axles. As such the belt is not twisted longitudinally and generally has a longer duty life as a result. In some cases as shown in the inventor's U.S. Pat. Nos. 6,135,835 and 6,231,406, the conventional belt is twisted longitudinally to transmit torque between wheels mounted on axles at an angle relative to each other. By twisting the belt, a simple low cost transmission between non-parallel axle's results, but it has been found that the belts experience significant wear and friction may reduce efficiency in some configurations.

In the embodiment of the invention illustrated, the belt 6 has protrusions 19 that can be engaged at any angle relative to the belt longitudinal axis since the protrusions are circular discs engagable equally at any angle about the 360° periphery of the disc. The recesses and edges of the discs are rounded as well to match geometrically, ensure positive mechanical engagement and to reduce friction. A further benefit of using rounded discs is that the recesses cradle the discs and provide for automatic self-centering of the discs as they engage the recesses in the wheels 16-18.

The use of a flexible belt 6 with idler wheels 17 oriented at any selected angle relative to the longitudinal axis of the belt 6 enables a very simple drive mechanism to be provided where the belt 6 is guided without significant twisting between the drive wheel 16 and driven wheel 18. This simple mechanism avoids the complexity of gear reduction and power losses resulting from use of conventional meshed gear transmissions, and avoids the wear and tear on the belt which results from twisting of a conventional belt. As well, the entire assembly can be economically constructed of robust plastic components that are accurately and inexpensively molded.

The band 22 can be manufactured of any flexible material. For example the band 22 and protrusions 19 may be molded integrally of the same material such as plastic or rubber with optional reinforcing core such as a metal wire, metal rope, carbon fiber, high strength plastic cable or fiberglass cable.

The band 22 may comprise a high strength core, such as wire rope, upon which are threaded beads of a large diameter to form the protrusions 19, and spacer beads of a smaller diameter to form the remainder of the band 22. Use of beads for the protrusions 19 mounted on a wire rope core for the band 22 also provides a beneficial degree of independent rotation for each bead to reduce any torque or twisting on the belt 6.

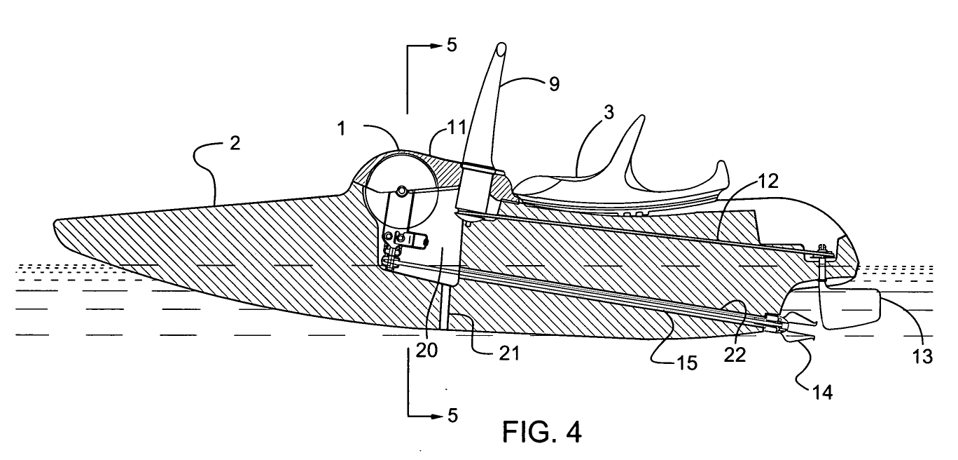

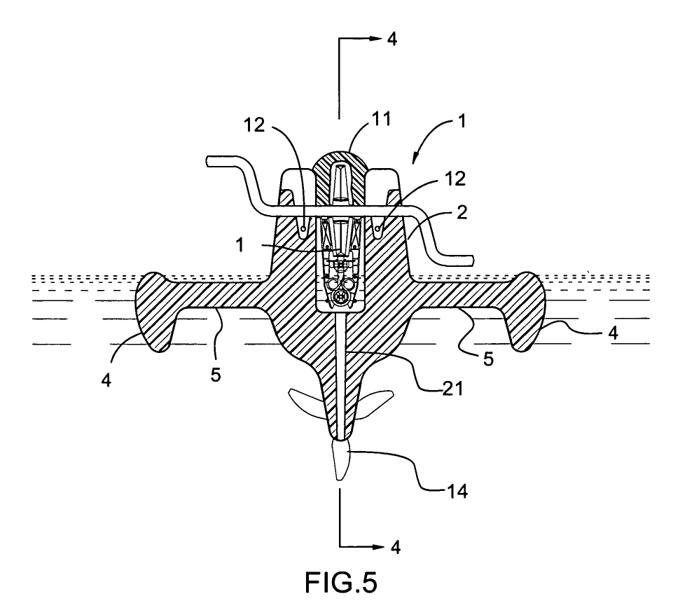

As seen in FIG. 4 and 5, in the example illustrated, water-cooling is provided by immersing the driven wheel 18 and a lower portion of the belt 6 in the water which floods into the lower portion of the sump 20 via water inlet 21. The motion of the belt 6 and driven wheel 18 splashes water for cooling within the interior of the housing 7 and circulates water within the sump 20. The circular disc shape of the protrusions 19 have a large surface area to capture water and carry it upwards as the belt 6 circulates about the wheels 16-18.

FIGS. 4 and 5 show a longitudinal sectional view through an aquatic vehicle that includes a transmission system 1 according to the invention. The hull 2 includes an elongate central hull body with a saddle seat 3 for straddling the hull body by the passenger. The hull 2 includes two elongate outriggers 4 disposed laterally outwardly from the hull body with outrigger arms 5 connecting the hull body to the outriggers 4. The outriggers 4 provide lateral stability and enable the passenger to bank the vehicle on curves. The outrigger arms 5 also provide a resting position for the feet of the passenger. The entire hull 2 can be formed as a hollow hull by plastic blow moulding processes well known to those skilled in the art.

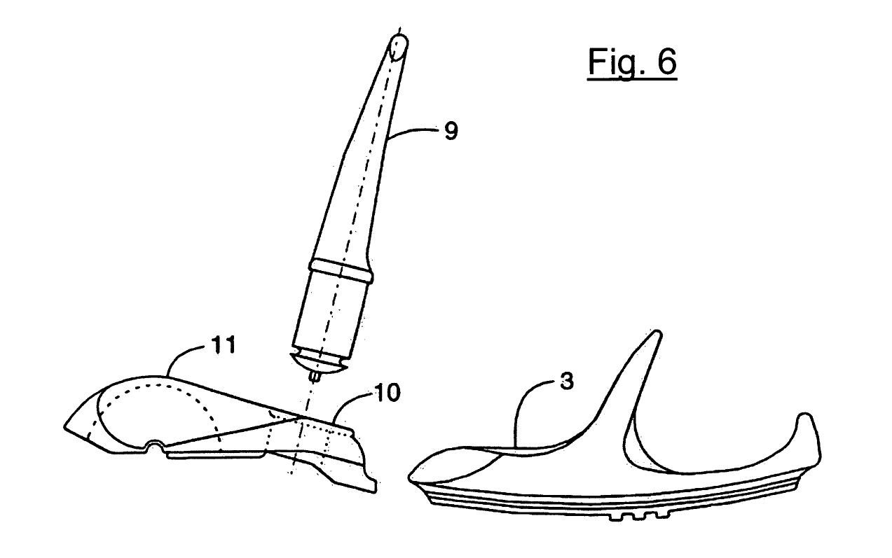

As seen in FIG. 6 the blow molded hollow T-bar steering handle 5 is journaled for rotation in an opening 10 in a plastic housing cap 11. The steering handle 9 is secured to cords 12 disposed in a groove in the body to rotate the rudder 13. The propeller 14 is rotated by a shaft 15 driven by the pedal powered transmission system 1

Referring to FIGS. 4 and 5, the aquatic vehicle houses a pedal powered transmission system 1 which in the embodiment illustrated is disposed within a sump 20 covered with a cap 12. The sump 20 is a hollow cavity formed within the hull 2 which includes a water inlet 21 that is disposed to flood a lower portion of the sump 20 with water when the hull 2 is immersed in water. The flooding of the lower portion of the sump 20 provides water for splash cooling of the transmission system 1 when the belt 6 rotates and draws water into the split housing 7.

Although the above description relates to a specific preferred embodiment as presently contemplated by the inventor, it will be understood that the invention in its broad aspect includes mechanical and functional equivalents of the elements described herein.

1. A pedal powered drive mechanism having a tranverse axis and a longitudinal axis, the mechanism comprising:
a housing and a drive belt having a central band spaced apart protrusions extending from the band;
an output shaft journalled in the housing aligned with the longitudinal axis, the output shaft having a driven wheel with circumferential recesses mating said protrusions of the belt; and
a crank shaft journalled in the housing aligned with the transverse axis, the crank shaft having a drive wheel with circumferential recesses mating said protrusions of the belt.

2. A drive mechanism according to claim 1 wherein the protrusions are radially symmetric about the band.

3. A drive mechanism according to claim 2 wherein the protrusions comprise discs having a circular profile transverse to the band.

4. A drive mechanism according to claim 3 wherein the protrusions comprise discs having rounded outward edges.

5. A drive mechanism according to claim 1 wherein the band is of material selected from the group consisting of: plastic; rubber; metal wire; metal rope; carbon fibre; high strength plastic cable; and fibreglass cable.

6. A drive mechanism according to claim 1 wherein the protrusions are of material selected from the group consisting of: plastic; and rubber.

7. An aquatic vehicle comprising:
a buoyant hull with a central longitudinal axis and saddle seat;
steering means mounted to the hull for manual steering by the passenger; and
pedal powered drive mechanism having a tranverse axis and a longitudinal axis, the mechanism comprising:
a housing and a drive belt having a central band spaced apart protrusions extending from the band;
an output shaft journalled in the housing aligned with the longitudinal axis, the output shaft having a driven wheel with circumferential recesses mating said protrusions of the belt; and
a crank shaft journalled in the housing aligned with the transverse axis, the crank shaft having a drive wheel with circumferential recesses mating said protrusions of the belt.
